(19) United States
(12) Patent Application Publication
(10) Pub. No.: US 2025/0257870 A1
(43) Pub. Date: Aug. 14, 2025

(54) EFFICIENT HIGH TEMPERATURE ELECTRIC CONVECTIVE HEATER AND METHOD TO MAKE SAME

(71) Applicants: Jainagesh Sekhar, Cincinnati, OH (US); Ramgopal Vissa, Hyderbad (IN); Sajja Sriramu, Hhderbad (IN); Venkata Burada, Cincinnati, OH (US)

(72) Inventors: Jainagesh Sekhar, Cincinnati, OH (US); Ramgopal Vissa, Hyderbad (IN); Sajja Sriramu, Hhderbad (IN); Venkata Burada, Cincinnati, OH (US)

(21) Appl. No.: 18/439,827

(22) Filed: Feb. 13, 2024

Related U.S. Application Data
(60) Provisional application No. 63/447,063, filed on Feb. 21, 2023.

(51) Int. Cl. F22G 1/16; F22B 1/30; H05B 3/44; H05B 3/74; H05H 1/24

(52) U.S. Cl. CPC F22G 1/165; F22B 1/303; H05B 3/44; H05B 3/74; H05H 1/24

(57) ABSTRACT

Presented are methods and apparatus for the increase of heating efficiency by the control of Reynolds number inversion in high temperature heating devices through the inclusions of flow modification devices precisely positioned in the hot fluid flow of the high temperature fluid heating device. Such flow modifiers allow for the internal temperature of the heated fluid to more closely reflect the fluid output temperature.

### CROSS-REFERENCE TO RELATED APPLICATIONS

This application claims the benefit of U.S. provisional application 63/447,063 entitled “Efficient High Temperature Electric Convective Heater And Method To Make Same” filed on Feb. 21, 2003, the disclosure of which is incorporated by reference herein in its entirety. Also features of the present application are based upon U.S. non-provisional application Ser. No. 17/062,656 entitled “Superheated Steam And Efficient Thermal Plasma Combined Generation For High Temperature Reactions Apparatus And Method” filed on Oct. 5, 2020, which is incorporated by reference in its entirety.

### BACKGROUND

Rapid decarbonization in the industrial sector is possibly the fastest way to stabilize global CO₂ emissions. Climate change, caused by CO₂ emissions, is one of the most significant challenges today. Energy-intensive industries use fossil fuel flames and combustion methods for a myriad of heating situations. Almost 30% of global CO₂ emissions result from fossil fuel heating due to industrial operations. As such, the industrial sector appears to have the quickest possible ability to lower CO₂ emissions.

One of the most impactful directions to reduce global CO₂ emissions is to replace flame/burner-type heating with efficient electrical convective heating. Avoiding flame and combustion heating will accelerate decarbonization. The social drivers for converting to electric energy heating from fossil-fired energy heating are becoming more compelling every day, as noted by recent countrywide climate extremes. A 1 MW electric device can prevent 360-1000 Kg of CO₂ emissions every hour. Regardless, fossil fuel heating dominates the industrial heating sector because of the cost. The inclusion of the social cost of emitting CO₂ effectively increases the cost of fossil fuel. Yet, it is still cheaper for companies to use fossil fuels. There is a need for electrical heating methods to yield greater efficiencies and higher temperatures.

There is now considerable interest in replacing CO₂-emitting combustion fuels with electrically heated convective air. The target is 0% CO₂ emission and at least 25% energy efficiency improvement for all electrical substitutions for process heating. Recent estimates suggest that global carbon dioxide emissions from fossil fuels hit a record high of 36.6 billion tons in 2022, corresponding to a record high of 442 ppm in the atmosphere.

Electric heating prevents, CO₂, NOxₓ, mercury, and SO₂ emissions associated with fossil-fuel combustion heating and benzene and formaldehyde release during processing. Converting to electric heating directly eliminates CO₂ emission. Such conversion also helps to alleviate land degradation and water pollution associated with usage and toxic runoff common in oil, gas, coal recovering, processing and moving. Worldwide, all energy-intensive industries that employ thermal processes are feeling the pressure to lower the environmental impact of their operations and make them more sustainable. These pressures come from governmental regulations and societal expectations. Additional CO₂ reduction beyond the one-to-one conversion is also possible because electric heating is much more efficient compared to fossil fuel heating. The gains in efficiency by switching to electric heating could reach around 30% for an identical objective.

Apart from emission mitigation, the benefits of electric heating include: electric heating offers accurate process temperature control with electronic feedback compared to uncontrolled combustion furnaces; burner combustion causes the high local center of the flame temperatures that cause unnecessary radiative losses and non-uniformities; and the higher the temperature the higher the productivity and the net overall energy efficiency. Many processes such as drying and chemical reactions are accelerated by increased temperature. Temperature speeds up the processes or lowers the size of the furnace or plant required for a given production rate. Combustion heating of chambers for large heat treating or for drying ore-beds is restricted in the actual temperature to 600-900° C. because flames, although hot, are localized. Electric heating, contrary to common belief, offers uniformity with temperatures that exceed flame heating.

### STATE OF THE ART

The current state of the art relative to industrial heating processes is mainly through the use of fossil-fuel-fired heaters as opposed to electrically powered convective heaters. As is well known, and described herein, fossil-fuel-powered heaters are prime producers of CO₂ and other greenhouse gasses. The major advantage of such heaters is the relatively low cost of fossil fuel as compared to electricity but only if the climate damage costs are not factored. The processing temperatures for industrial decarbonization lie between 700° C. and 1300° C. The higher the temperature, the higher the productivity, enabling a lower total energy usage. Flame heating in large devices (such as furnaces, dryers, and process chambers), offers, at best, a heating temperature of around 900° C. with very poor chamber uniformity above 800° C. A more efficient, higher temperature, and environmentally cleaner operating heating unit is needed.

In short, several technical challenges in obtaining the best decarbonization scenario that can accelerate CO₂ emission reduction. Firstly, the current industrial convective equipment operates mainly in the 900-1050° C. range. These temperatures are too low for optimal efficiency. The applicant has had some promising preliminary results that could result in electric convective air heater operation temperatures exceeding 1200° C.

Secondly, pressure in hot generators is an issue. Along with the high-temperature requirement, providing a low-pressure drop is essential; otherwise, the cost of blowers/air movers becomes prohibitively expensive. However, the very low-pressure drop generators are limited to the 700° C. range because of a high-temperature Reynolds number inversion problem. The Reynolds number inversion problem is where turbulent flow becomes laminar when the Reynolds number decreases. This situation leads to zones in a heating unit that are hotter than the output which may lead to burnout of heating elements.

Thirdly, the typical energy efficiency of fossil fuel heating devices is very low, approximately 50%. Combustion flame burners are difficult to control accurately for temperature. The efficiencies offered by electrical heating devices are much higher (even as high as 95%) making them attractive. However, the energy efficiencies for air heating devices above 1000° C. typically fall off rapidly and approach a low of 70% above 1100° C. The efficiency loss is likely to result from the inversion issue mentioned above.

Lastly, and most importantly, the current technology is limited by the condition where, when output temperatures of electric heat generation units exceed 1000° C. a Reynolds number inversion causes heating elements to burn out. The key scientific challenge is to overcome the Reynolds Number Inversion Problem.

### SUMMARY

This application presents new technical directions for improving air heating efficiency at temperatures above 900° C. (targeting 1200° C.) that will also support the high temperature and low-pressure drop requirements of convection heating. This application describes methods and apparatus that will overcome the technical challenges including the efficiency of electrical heating units and the Reynolds number inversion problem existing in the current state of the art as described above.

### DRAWINGS-FIGURES

FIG. 1 is an isometric view of an embodiment of a high temperature plasma generation device employing an electrically charged heating element.

FIG. 2 is an additional isometric view of an embodiment of a high temperature plasma generation device employing an electrically charged heating element.

FIG. 3 is a cut away view of the embodiment of the high temperature plasma generation device employing an electrically charged heating element.

FIG. 4 is a side view of an embodiment of a high temperature superheated steam generation device employing an electrically charged heating element.

FIG. 5 is an isometric view of an embodiment of a high temperature superheated steam generation device employing an electrically charged heating element.

FIG. 6 is a top view of a flow modifier assembly.

FIG. 7 is a side view of a flow modifier assembly.

FIG. 8 is a view showing the positioning of a flow modifier assembly through the cross-section of a heating element and surrounding ceramic refractory.

FIG. 9 is a cut away view of a temperature heating device showing direction of fluid flow, placement of flow modifier assemblies and TC zones.

### DRAWINGS—REFERENCE NUMERALS

10 electrically charged heating element
17 power connection
100 plasma generator
102 casing
103 intake end
104 exhaust end
107 intake flange
109 exhaust flange
110 intake cap
112 intake cap flange
115 gas intake
120 exhaust cap
122 exhaust cap flange
125 exhaust port
130 flange bolt
140 refractory
142 channel
150 thermocouple port
200 superheated steam generator
210 water inlet
215 manifold
216 manifold flange
220 water lines
300 flow modifier assembly
315 assembly rod
320 modifier spool

### DESCRIPTION

Electrically powered convective heaters are available for temperatures up to 600° C. from several suppliers and up to 1000° C. from the applicants. The operation of conductive fluid heaters is as follows. A fluid (air or other gas) is projected, by a fan, blower, or pressure system through a ceramic refractory lined casing equipped with electrically charged heating elements placed along the length of the inside of the casing. The projected fluid travels past and around the heating elements picking up the heat emitted by the elements. The elements connect to a power source and power controller. The controller also regulates temperature with feed-back thermocouples positioned along the length of the fluid flow and at the point of processing. A heated fluid is thereby produced at the outlet end. Although this is simple conceptually, there are several challenges that have prevented effective deployment in the industrial sectors.

### DETAILED DESCRIPTION

### Technical Approach and Solution

Two types of technical approaches are feasible. One that uses a very high-temperature heating element and the other that eliminates some of the hot spots causing flow inversions. The first approach is using high-temperature MoSi₂ heating elements as the main heating elements or as in the form of an add-on module.

The second approach consists of the judicious placement of fluid flow modifiers within the heated fluid flow of a heated fluid generation device will counteract Reynolds number inversion within the device and allow for greater heating efficiency. Such flow modifiers are placed through the refractory layer of a heater and into the heated fluid stream. The temperature within the generation device will be nearer to the exit temperature of the gas thereby preventing overheating and the burnout of heating elements.

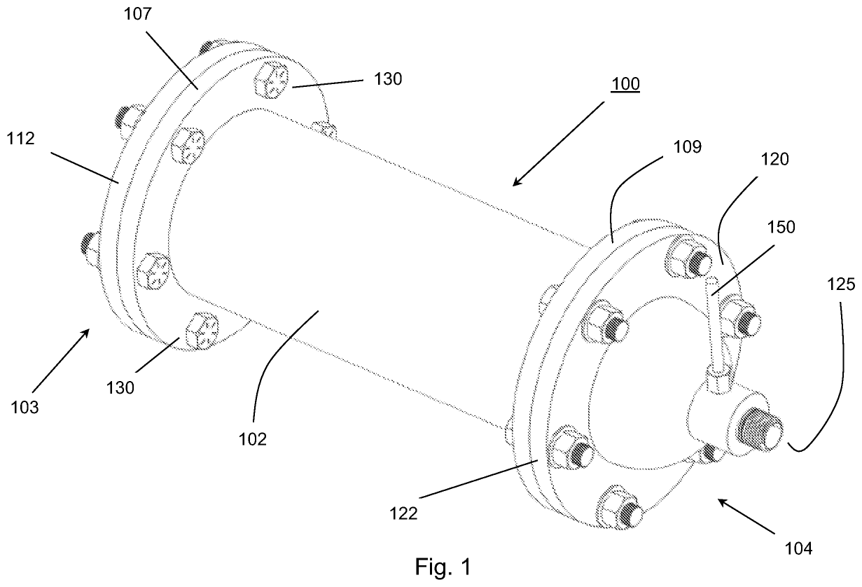

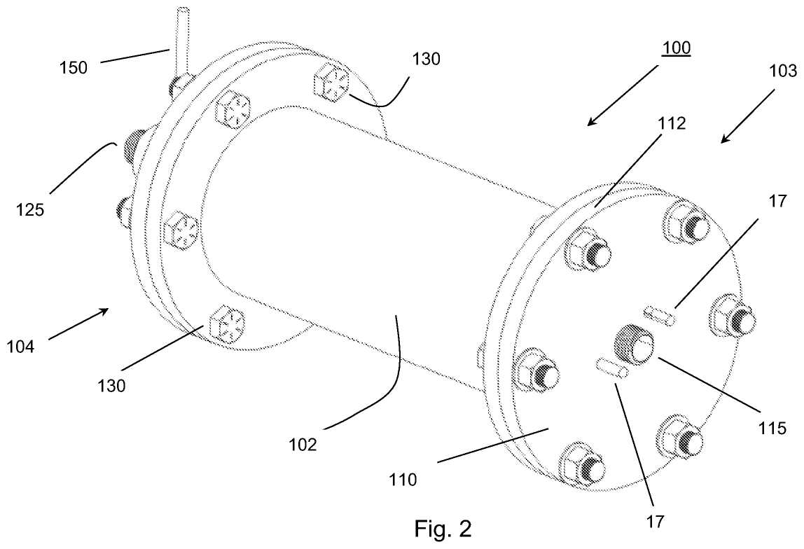

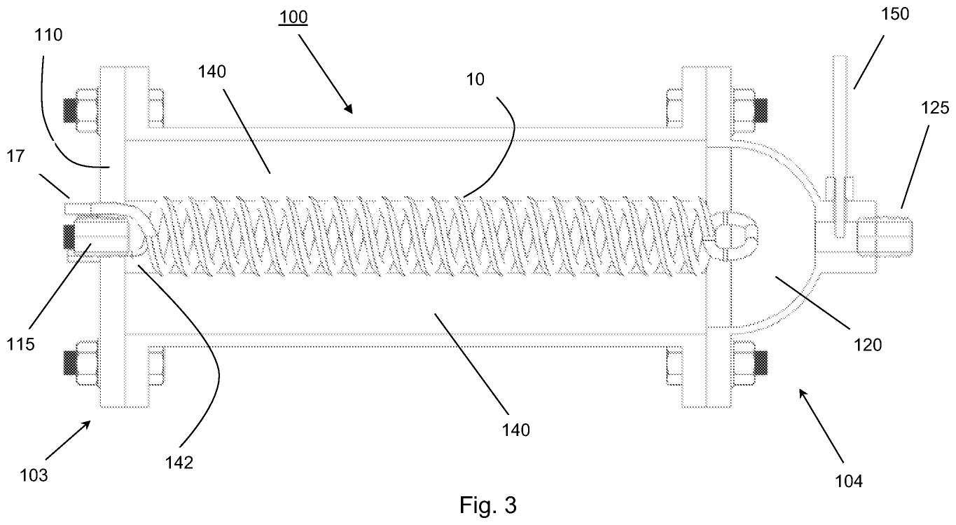

FIGS. 1-3 present an embodiment of a plasma generating device 100 comprised of a casing 102 having an intake end 103 terminating in an intake flange 107 and an exhaust end 104 terminating in an exhaust flange 109. In this embodiment the casing 102 is tubular in configuration though other geometries are anticipated. On the intake end 103 of the casing 102 is an intake cap 110 having an intake cap flange 112 which is attached to the exhaust flange 107 by multiple flange bolts 130 and gas intake 115 attached to a gas or air supply (not pictured).

An exhaust cap 120 is attached to the exhaust flange 109 by flange bolts 130 to the exhaust cap flange 122 of the exhaust cap 120. The exhaust cap 120 terminates at exhaust port 125. The gas source may be under some pressure such as a pump or a fan to provide a positive flow of gas into the generator 100. The casing 102 and the exhaust cap 120 may be provided with a thermocouple port 150 if desired.

The interior of the casing 102 is lined with refractory 140 which may be porous. Refractory material may be broadly defined as an insulation region and could be gas, solid, porous solid, liquid, plasma or combinations thereof. The refractory 140 defines a channel 142 in which a double helically configured heating element 10 is contained. The element 10 may be in contact with the refractory 140. The channel 142 may have straight walls in contact with element 10 or the channel 142 may have a rifled or grooved surface corresponding to the geometry of the heating element 10 allowing for a tight fit. A power source (not pictured) provides electrical current to power connections 17 which are attached to the element 10. The power connections 17 and thermocouple part 150 may be positioned elsewhere if necessary.

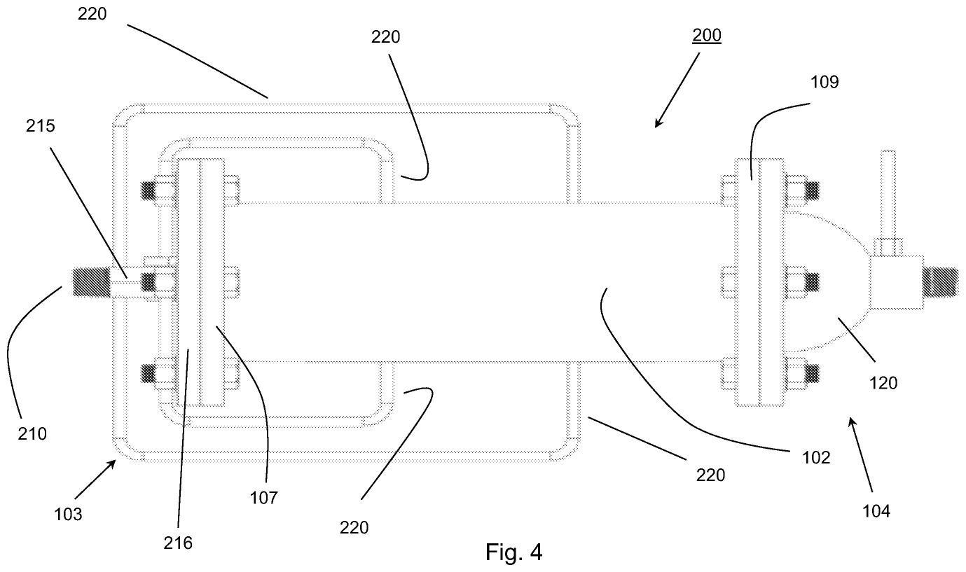

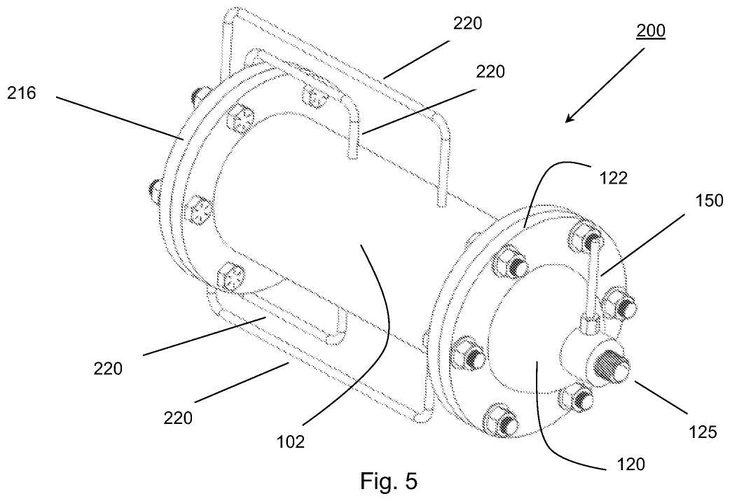

FIGS. 4 and 5 show superheated steam generator 200 that is comprised of many of the same features as the plasma generator 100. The superheated steam generator 200 is comprised of a casing 102 having an intake end 103 terminating in an intake flange 107 and an exhaust end 104 terminating in an exhaust flange 109. In this embodiment the casing 102 is tubular in configuration though others are anticipated. On the intake end 103 of the casing 102 is a manifold 215 having a manifold flange 216 which is attached to the exhaust flange 107 by multiple flange bolts 130 and water inlet 210 attached to a water supply (not pictured). The water may be de-ionized. Water lines 220 connect the manifold 215 to and through the casing at pre-determined positions to distribute the water to desired locations along the length of the generator 200. The water source may be under some pressure, such as a pump, to provide a positive flow of water into the steam generator 200.

An exhaust cap 120 is attached to the exhaust flange 109 by flange bolts 130 to the exhaust cap flange 122 of the exhaust cap 120. The exhaust cap 120 terminates at exhaust port 125. The water source may be under some pressure such as a pump to provide a positive flow of water into the generator 200. The casing 102 and the exhaust cap 120 may be provided with thermocouple ports 150 if desired. A pressure gauge (not pictured) may also be affixed to the casing 120.

As described previously for plasma generating device 100, the interior of the casing 102 of steam generator 200 is lined with refractory 140 which may be porous. The refractory 140 defines a channel 142 in which a double helically configured heating element 10 is contained. Other element shapes and geometries are contemplated as well. The element 10 may be in contact with the refractory 140. The channel 142 may have straight walls in contact with element 10 or the channel 142 may have a rifled or grooved surface corresponding to the geometry of the heating element 10 allowing for a tight fit. A power source (not pictured) provides electrical current to power connections 17 which are attached to the element 10. The power connections 17 and thermocouple ports 150 may be positioned elsewhere if necessary.

The water that is introduced into the casing 102 via the water lines 220 comes into contact with the refractory 140, which is pierced by the water lines 220 within the casing 102 and may be converted into steam upon contact with the heating element 10. As the water/steam mix makes its way through the water lines 220 and the refractory 140 towards the heating element 10 it picks up more heat and efficiently becomes superheated.

Superheated steam is generated at one atmosphere by the generator 200. Pressure does not build up in the generator since the exhaust port 125 is open to the atmosphere. Impingement of the water on the hot heating element 10 provides an expansion of the water allowing for it to be expelled from the generator 200 under its own power. No pressurization of the steam is therefore necessary. The superheated steam is at a temperature and condition to allow the generation of thermal plasma with activated species.

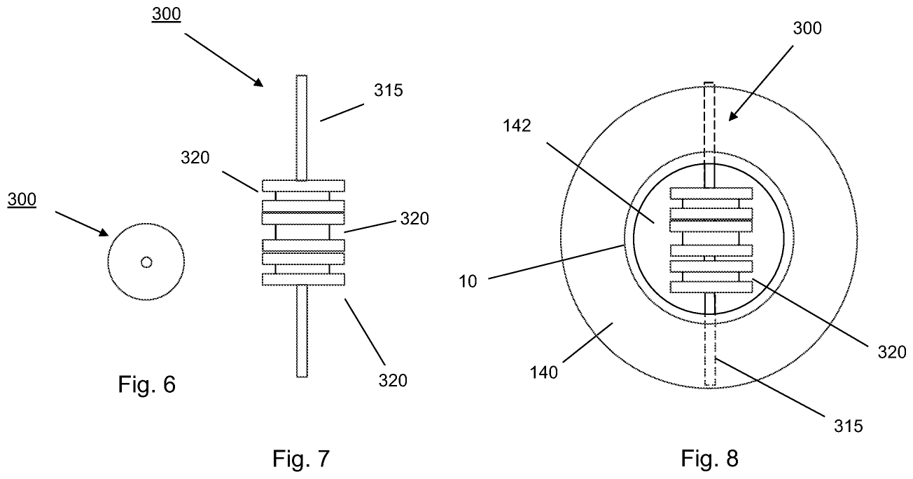

FIGS. 6 and 7 show an exemplary embodiment of a flow modifier assembly 300 for use in a hot fluid generation device such as a plasma generator or a superheated steam generating device. The flow modifier assembly is comprised of multiple spools 320 stacked upon one another. The spools 320 may be comprised of discs themselves affixed and stacked upon each other. The spools 320 are round in cross-section ((FIG. 6) but other geometries are anticipated as well) pierced by a hole through their cross-section. A rod 315 is positioned through the holes allowing the spools 320 to be stacked thereby forming the assembly 300. The spools 320 may slide freely on the rod 315 and both are comprised of a high-temperature material such as ceramic. The surfaces and edges of the spools 320 and rod 315 may be smooth to reduce friction.

FIG. 8 shows the placement of the assembly 300 relative to the heating element 10 and refractory 140 of hot fluid generating device. The assembly 300 is positioned so that its round cross-section is at ninety degrees to the cross-section of the heating element 10 and refractory 140 and perpendicular to the fluid flow. The assembly 300 acts to take up cross-sectional area of the channel 142 that the element is positioned in thereby increasing the velocity of the fluid flow and introducing turbulence. The size and number of the spools 320 can be changed to more or less restrict the fluid flow.

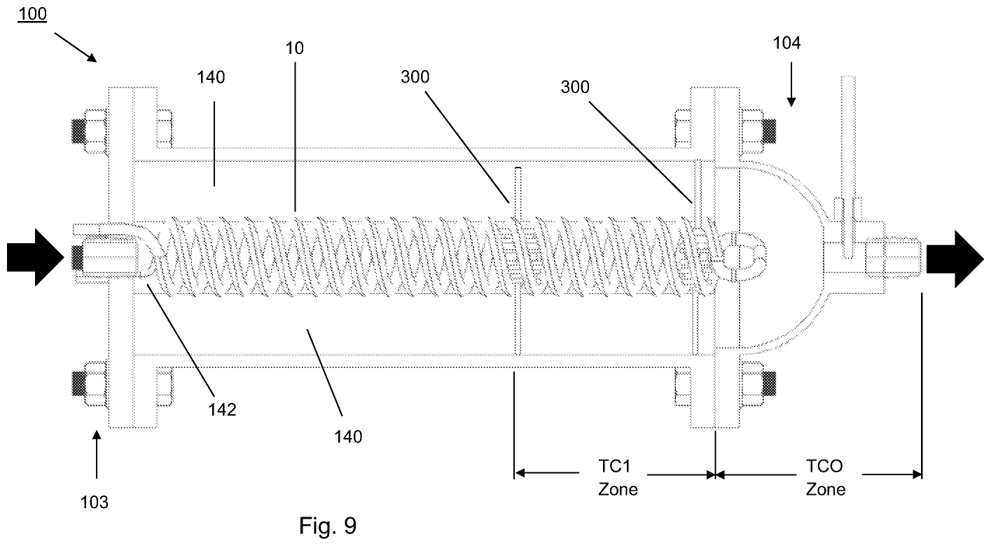

FIG. 9 is a length-wise cross-section of a thermal plasma or gas heater 100 equipped with fluid modifier assemblies 300. The direction of flow through channel 142 and in contact with element 10 is indicated by the black arrows at the intake end 103 and exhaust end 104. The locations of the TC1 zone and the TCO zone are indicated as well. In this embodiment a first assembly 300 is positioned inside the heater 100 roughly one third from the exhaust end 104 of the heater 100 just within the TC1 zone. A second assembly 300 is located near the exhaust end 104 and TCO zone. It is anticipated that other assemblies 300 could be placed at other positions.

In this embodiment both assemblies 300 are affixed in the same manner (FIGS. 8-9). The spools 320 are positioned within the element 10. The round cross-section of the spools 320 is perpendicular to the round cross-section of the element 10 in order that the gas flow passes at ninety degrees to the round cross-section of the spools 320. The rod 315 passes through the round cross-section of the spools 320 and is secured in the refractory 140. It is anticipated that a single assembly 300 or more than two assemblies 300 could be employed or in different positions than described. It is further anticipated that any obstruction (the flow modifier may be considered as such an obstruction) in the flow may cause a modification in the fluid flow resulting in increased velocity, Reynolds number and turbulence and a decrease in the TC1 zone.

Though the presented flow modifiers may be used to increase the flow of a fluid to prevent Reynolds number inversion, they may also be used if needed to decrease the flow by increasing the cross-sectional area of the flow thereby decreasing the velocity of the fluid. Such may be desirable in some cases where the efficiency of the heater is adversely affected by use of modifiers to increase the velocity of the fluid flow. It is therefore anticipated that fluid modifiers may be used to affect the cross-sectional area and thus the velocity of the flow by the placement of modifies within the flow. A combination of modifiers that increase and decrease the flow at separate points along the flow path may provide the best efficiency for the heater system.

An electric heater works by converting electrical work into thermal energy. Regardless, when the flow velocity at the exit is different (higher) than the inlet, a fixed mass flowing through the electric work is converted into thermal energy and work (extra momentum). As flow modifiers change the exit velocity, there is a possibility of loss of efficiency. Thus, the use of flow modifiers that decrease the exit velocity can improve the efficiency of an electric heater and may be used for that purpose. In such cases, the modifiers will provide an additional cross-sectional area near the exit or within the heating elements. The modifiers may be ceramic-lined area enhancers. Such modifiers may take the form of tubes or other shapes that increase the exit area and reduce the flow velocity for the same volume flow rate. Combined with Reynold number inversion type of flow modifiers, the enlarging exit-area flow modifiers can prevent hot spots yet not lose efficiency. Such features are beneficial above 700° C. exit temperatures.

### Summary of the Preliminary Results

As stated above, because of a Reynolds number inversion a temperature peak is encountered before the temperature at the exhaust or exit of the hot fluid. This imbalance in temperatures can lead to wasted power to attain a desired exhaust temperature. At worst, to reach a desired exhaust temperature may require the heating of heating elements within a heater to the point of their failure due to burnout. Herein, the area of the temperature peak will be called the TC1 zone temperature, which, in all current designs of heater elements, is always greater than the output or TCO zone temperature. The TC1 zone is found from the output to roughly one third behind the output or exhaust end of the heater relative to the length of the element 10 (See FIG. 9). The TC1 zone may also be called the hot zone. The TCO zone is the area past the end of the element 10 (FIG. 9). This inversion problem gets worse (the TC1 zone temperature increase) as the TCO zone temperature is taken above 1000° C. Consequently, as the TC1 zone temperature can easily exceed the element temperature for metallic elements, these elements burn out. The goal is to devise methodologies to overcome the Reynolds number inversion allowing higher TCO zone temperatures without element burnout. Two technical solutions were considered.

Improved Material for the Heating Elements Approach: One approach is to consider a much higher-rated heating element. Metallic elements are limited to about 1350° C. Ceramic elements may be used beyond this temperature. Molybdenum disilicide is a material that can reach 1900° C. and is the most attractive and effective high-temperature ceramic element material. However, MoSi₂ is expensive and brittle, therefore an approach employing this material can at best be using an add-on module comprising MoSi₂ heating elements.

It is anticipated that a module comprising a casing lined with refractory material for insulation and heat transfer surrounding a chamber containing electrically charged MoSi₂ heating elements. The elements are themselves connected to an electric power source. Appropriate thermocouples and controls will be utilized. The casing is anticipated as being round in cross-section, but other geometries are anticipated as well. Materials used for the casing and refractory will be those well known in the art.

In use, the module would be placed in a manner so that that the heated exhaust from the high-temperature fluid generator would be directed through the cross-section module and past the charged MoSi₂ elements and be further heated to needed levels. The module could be physically attached to the exhaust end of the fluid generator by clamps, bolts or threads. The module could also be rigidly affixed in line with the generator exhaust without attachment. As such the elements of the generator would not have to be strained, possibly burnt out, to reach desired temperatures. The module would boost the exhaust temperatures as needed.

Convective heater configurations made with Molybdenum disilicide materials were studied. The first MoSi₂ test unit was constructed, and the air was successfully heated to 1200° C. However, using straight-sided elements is cumbersome and not optimal for a reasonable watt density provision for commercial use. But this test gives confidence that a module may be affixed to a MoSi₂-equipped heater for future testing. The material can also be shaped into a coil and more specifically shaped into a coil in coil configuration which is known to optimize heat transfer with minimal pressure drop. The main challenge is to successfully configure the material into high KW modules in a tight space that can attach to kilowatt and megawatt 900° C.-1000° C. gas heating electrical units. In principle, a successful module can also improve traditional gas convective generators with an electrical enhancer. As MoSi₂ is expensive and possibly brittle for heavy velocity use it is best to consider the last section of air that needs to be heated from 900° C. or above for placement of a with MoSi₂ heating elements.

Improved Design with Flow Modifier Approach. A second promising approach that can permit the use of the lower temperature ductile metallic elements yet reduce the TC1 zone impact is with the use of flow modifiers. This approach involves improving the temperature capability of existing heaters by reducing surface load and preventing the Reynolds number inversion problem with flow modifiers. Tests were conducted to carefully asses the impact of flow modifiers. It is anticipated that through the use of flow modifiers the TC1 zone could be pushed out of the heater itself and into the output or exhaust. This would improve efficiency greatly as well as increase element life since the temperature would be more uniform and the hottest temperature would be the exhaust.

The initial grouping of tests 1-4 was designed mainly to understand and gain experience with the test jig and the behavior of the heater module. During these tests, four thermocouples were positioned, to read the temperature in the center of the coil. A mass flow meter was used to measure the flow velocity. True RMS meters were used for the measurement of volts and amps. The pressure was measured with an open-ended “U” tube manometer in a water column. During these first four tests, the TC1 zone temperature would start overshooting the control thermocouple which was at the “U” tip or output end (5 mm away) of the element. In test 4, the area and volume of the exit nozzle were calculated, and changes were made to reduce the pressure drop in that region. This helped in increasing the velocity at that point which made the TC1 zone area more stable, and the TCO zone 340 temperature went up to 1000° C. during the first trial.

In test 5, the nozzle area was trimmed which improved the TC1 zone area. Tests 6 and 7 were a repeat of test 5. In tests 8 and 9, a stainless-steel liner was used to see if it would cause any improvement on the “exit thermocouple” which was always lagging from the “control thermocouple” by about 50° C. This plan led to worse results than tests 6 and 7 and was therefore rejected. All along, the fall in the velocity of air that was pushed by the blower was observed with the rise in temperature giving a feel of an increase of viscosity along the length of the module. The blower itself maxed out at a cold start. This however helped lead to an understanding of what was happening because of this and a plan to jettison (viscous material) it out by increasing the velocity in that region. The inversion happens at a point above 800° C. At this point, there was planning for accelerators and an “insertion thermocouple” to measure at various depths to have a better understanding of the flow temperature issues.

Based on all the previous tests, test 10 incorporated flow modifiers. These had three different configurations placed along the length of the coil to progressively increase or decrease the velocity of flow. This was determined by looking at the progressive decrease of the air velocity curve. The TC1 zone thermocouple failed along the way. However, an “insertion thermocouple” was used with which measurements were taken at one-inch intervals. This gave a better temperature profile. Mineral-insulated “OMEGA thermocouple” was used for this purpose. Tests 11 and 12, were mainly to repeat more cycles at 1000° C. with minor changes in the nozzle before attempting 1100° C.

Test 13 was the first control ramp to 1100° C. and was a perfect run. Test 14 was a power failure simulation test. Two power failure conditions were simulated. One at 900° C. with recovery and another failure at 1000° C. The power and blower were shut down. The temperature would surge by about 6 to 10° C. in around 10-14 seconds and then start dropping. No damage to the element was found.

Test 15 was run without the flow modifiers. The coil was overheating as far as 400 mm. This run was done at 1000° C. It was not wanted to go beyond this. In this test, we added one more modifier at the “0” position. This brought control and exit to equality. The was a stable run throughout. The next plan is to add 3 more accelerators at points 1, 2 and 3. This should bring the internal high temp levels to about 20° C. maximum peak above for the TC1 zone over the peak output. Once this is achieved, there is a possibility that the output can reach 1200° C. and remain stable.

The above descriptions provide examples of specifics of possible embodiments of the application and should not be used to limit the scope of all possible embodiments. Thus, the scope of the embodiments should not be limited by the examples and descriptions given but should be determined from the claims and their legal equivalents. The described methods and devices may be used on any heating device with any type or style of heating element where a flow passes through a space containing such elements. In any case flow modifiers would restrict the flow area and increase the velocity of the flow, increase turbulence and reduce Reynolds Number Inversion problems.

We claim:

1. A flow modifier to be inserted into a heated fluid flow of an electrically powered convective heater the low modifier comprising an obstruction inserted into the heated fluid flow.

2. The flow modifier of claim 1 wherein the electrically powered convective heater is comprised of a heating element confined in a channel through ceramic material, the channel having a length and a cross-section perpendicular to the length through which the heated fluid flow passes along the length of the channel wherein the flow modifier causes an alteration in the area of the cross-section of the channel thereby altering the velocity of the hot fluid.

3. The flow modifier of claim 2 wherein the alteration in the area of the cross-section is a decrease thereby increasing the velocity of the fluid.

4. The flow modifier of claim 2 wherein the alteration in the area of the cross-section is an increase thereby decreasing the velocity of the fluid.

5. The flow modifier of claim 3 wherein the modifier comprises at least one spool comprised of discs having a round cross-section and a rod placed through the at least one spool wherein the modifier is positioned within the channel with the round cross-section of the discs being perpendicular to the round cross-section of the channel and where the rod is inserted in the ceramic material.

6. The flow modifier of claim 1 wherein the obstruction is comprised of ceramic material.

7. The flow modifier of claim 4 wherein the obstruction comprises smooth surfaces and rounded edges.

8. An electrically powered convective heater having at least one flow modifier placed strategically along a path of a heated flow within the heater in a manner to affect velocity of the heated flow.

9. The electrically powered convective heater of claim 8 wherein the at least one flow modifier is an obstruction inserted into the heated flow.

10. The electrically powered convective heater of claim 8 wherein the electrically powered convective heater is comprised of a heating element confined in a channel through ceramic material, the channel having a length and a cross-section perpendicular to the length through which the heated fluid flow passes along the length of the channel wherein the flow modifier causes an alteration in the area of the cross-section of the channel thereby causing an alteration in the velocity of the hot fluid.

11. The electrically powered convective heater of claim 10 wherein the alteration in the area of the cross-section is a decrease and thereby the alteration to the velocity of the fluid flow is an increase thereby increasing turbulence in the channel resulting in the prevention of Reynolds number inversion.

12. The electrically powered convective heater of claim 10 wherein the at least one modifier comprises at least one spool comprised of discs having a round cross-section and a rod placed through the at least one spool wherein the modifier is positioned within the channel with the round cross-section of the discs being perpendicular to the round cross-section of the channel and where the rod is inserted in the ceramic material.

13. A method to affect the efficiency of an electrically powered heating device comprising introducing at least one flow modifier in a heated fluid flow inside of the heating device thereby causing an alteration of the heated fluid flow thus causing an alteration in the velocity, turbulence and Reynolds number of the heated fluid flow.

14. The method of claim 13 wherein the at least one flow modifier is an obstruction inserted into the heated flow.

15. The method of claim 13 wherein the electrically powered heater device is comprised of a heating element confined in a channel through ceramic material, the channel having a length and a cross-section with an area perpendicular to the length through which the heated fluid flow passes along the length of the channel wherein the flow modifier causes the alteration in the area of the cross-section of the channel thereby causing the alteration in the velocity of the hot fluid.

16. The method of claim 13 wherein the alteration in the area of the cross-section is a decrease thereby increasing the velocity of the fluid.

17. The method of claim 13 wherein the alteration in the area of the cross-section is an increase thereby decreasing the velocity of the fluid.

18. The method of claim 16 wherein the at least one modifier comprises at least one spool comprised of discs having a round cross-section and a rod placed through the at least one spool wherein the modifier is positioned within the channel with the round cross-section of the discs being perpendicular to the round cross-section of the channel and where the rod is inserted in the ceramic material.

19. The method of claim 17 wherein the at least one modifier comprises a tube that increases the area of the cross-section.

20. The method of claim 13 wherein the electrically powered heating device has an intake end and an exhaust end and a hot zone within the channel wherein the at least one modifier is positioned in the hot zone of the electrically powered heating device.
